(19) United States
(12) Patent Application Publication
(10) Pub. No.: US 2010/0211506 A1
(43) Pub. Date: Aug. 19, 2010

(54) MOBILE TRANSACTION SYSTEM AND METHOD

(75) Inventors: FENG-LIN CHANG, TAIPEI CITY (TW); HUA-SEN CHENG, TAIPEI CITY (TW); LI-CHANG LIU, TAIPEI CITY (TW); CHIH-HSIEN LIN, TAIPEI CITY (TW)

Correspondence Address: ROSENBERG, KLEIN & LEE, 3458 ELLICOTT CENTER DRIVE-SUITE 101, ELLICOTT CITY, MD, 21043, US

(73) Assignee: SIMPLEACT INCORPORATED, TAIPEI CITY (TW)

(21) Appl. No.: 12/704,026

(22) Filed: Feb. 11, 2010

(30) Foreign Application Priority Data
Feb. 19, 2009 (TW) 098105239

(51) Int. Cl. G06Q 30/00; H04L 9/00; G06Q 20/00; G06K 7/10; H04L 29/06; G06F 17/30

(52) U.S. Cl. 705/65; 705/75; 235/375; 713/151; 707/802; 707/E17.005

(57) ABSTRACT

A mobile transaction system and method are carried out by a plurality of remote trading servers, a mobile barcode trading device and a data transmission server. The remote trading server generates and transmits a two-dimensional barcode image to at least one store client to display thereon after a user selects at least one product from the store client. The mobile barcode trading device captures the two-dimensional barcode image, analyzes the two-dimensional barcode image to obtain an encrypted key data and a trade data, and generates an encrypted payment data by the encrypted key data after the user input a payment data. The encrypted payment data and the trade data are combined to generate an encrypted trade data being transmitted to at least one of a plurality of the remote trading servers via a data transmission server, so as to carry out a mobile transaction.

### FIELD OF THE INVENTION

The present invention is related to a transaction system and method, and more particular to a mobile transaction system and method utilizing to decrypt a two-dimensional barcode image to obtain an encrypted key data and a trade data.

### BACKGROUND OF THE INVENTION

Today, there are many transaction methods without physical cash are well known by people, such as credit card, visual cash for internet and mobile phone due to the advanced technology.

Take the transaction method of the mobile phone for example. There are two types of the transaction method in generals. One is management by a telecommunications company or a third-party company. Regarding to management by the telecommunications company, the mobile phone can be allowed to pay the payment utilizing the information of the Subscriber Identity Module (SIM) and the verified data. Finally, the payment can be deducted from credit card, bank account, or telephone bill.

In the prior art, another transaction method utilizing mobile phone is described below. A phone number and data of a mobile phone can be confirmed by a telecommunications company via a short message sending by the mobile phone, and the payment is deducted from telephone bill. However, a consumer can not be allowed to choose any other telecommunications company for different credit cards, or change telecommunications company any time, because the consumer must show the credit card that contracted with the telecommunications company to shop. If the consumer dose not carry with the credit card, the consumer will not completely any payment. Besides, if the consumer wants to change another telecommunications company, the consumer must to have a new contract with new telecommunications company.

Another transaction method via third-party company in the prior art is described below. A third-party company, such as Paypal and EZPay, stores the credit card data in a database, and receives the cash that the consumer pay for the product from the credit card company. Next, the third-party company gives the cash to the shop.

For example, if a consumer wants to pay a payment to an internet shop, the consumer needs to input a payment information, such as a credit card number, a valid data, a cost and a shop code. Next, the payment information will be transmitted sequentially to a connecting server of the telecommunications company, and the transaction server, which is authorized by the telecommunications company or bank, of the internet shop. Finally, the payment information will be transmitted to the bank to complete the transaction. In this transaction method, the consumer needs to input a lot of data via a small keypad of the mobile phone that is very inconvenient for consumer. Besides, many mistakes may be occurred when the consumer inputs the data. Moreover, the credit card data of consumer may be kept by the internet shop or unknown someone when the credit card data passes through the transaction server of the internet shop.

Another transaction method via mobile phone and the third-party company in the prior art is described below. When a consumer wants to pay a payment, the consumer call a phone to provide identify, cost, and a shop code to a payment server of the third-party company. Next, the payment server transmits a random transaction code to the consumer. Next, the consumer gives the transaction code to the shop and the shop calls to the payment server to give the transaction code and confirms the transaction time and cost to complete the transaction. In this method, the consumer and the seller need to register account in the payment server, and the consumer needs to provide the credit card information to the payment server. Therefore, the credit card information may be known by someone from the payment server. Besides, when a trade dispute is occurred, the credit card company of the credit card of the consumer will not solve the problem due to the consumer and the shop transact to the third-party company directly.

Another transaction method via the mobile phone is provided in the prior art, and the consumer inputs the payment information, such as a credit card number, a valid data, a cost and a shop code, and transmits the payment information to the shop via short message from the mobile phone. Next, the shop transmits the payment information to a bank to complete the transaction. In this transaction method, the consumer needs to input a lot of data via a small keypad of the mobile phone, and the shop may be keeping the payment information.

In conclusion, the transaction method via mobile phone in the prior has some problems, such as “inconvenient using”, “inputting mistake” and “the credit card data leakage”.

### SUMMARY OF THE INVENTION

Due to that there are many serious problem, such as “inconvenient using”, “inputting mistake” and “the credit card data leakage” in the prior arts, the primary objective of the present invention is to provide a mobile transaction system that the credit card is not necessary and the quantity of imputing data is decreased. Moreover, the transaction can be completed more safely due to the transaction data is encrypted.

The object of the present invention is to provide a mobile transaction system and method. A two-dimensional barcode image can be captured for a mobile transaction, and the two-dimensional barcode image can be displayed on the shop client after a user selects at least one product. The mobile transaction system comprises a plurality of remote trading server, a mobile barcode trading device and a data transmission server. The remote trading servers are electrically coupled to the shop client. One of the remote trading servers receives a trade data transmitted by the shop client after the user selects the product, and generates a two-dimensional barcode to the shop client.

The mobile barcode trading device comprises an image capturing unit, a barcode analysis unit and a payment unit. The image capturing unit is for capturing the two-dimensional barcode image. The barcode analysis unit is electrically coupled to the image capturing unit to decrypt the two-dimensional barcode image to obtain an encrypted key data and the trade data. The payment unit is electrically coupled to the barcode analysis unit, and is for generating an encrypted payment data according to the encrypted key data after the user inputs a payment data for the user paying the payment of the product.

The data transmission server is electrically coupled to the remote trading server and the mobile barcode trading device. The encrypted payment data and the trade data are combined to generate an encrypted trade data. The encrypted trade data is transmitted to the one of the remote trading servers via the data transmission server and at least one transmission path.

Preferably, the encrypted key data is randomly generated by the remote trading server. The mobile barcode trading device of the mobile transaction system can include a payment unit. The payment unit includes at least one electronic wallet manager. If the user does not carry with a credit card, the user can input the payment code via payment unit, chose an electronic wallet manager, and then the payment unit encrypts the wallet manager information according to the encrypted key data to transmit to the remote trading server to complete the transaction.

Comparing to the transaction method in the prior art, the mobile transaction system and method of the present invention utilizes the payment unit to pay the payment of the product. Therefore, the user can complete the transaction without a credit card. The mobile barcode trading device of the mobile transaction system can capture the two-dimensional barcode image, and the barcode analysis unit can decrypt the two-dimensional barcode image to obtain the encrypted key data and the trade data. Obviously, in the present invention, the input mistake can be decreased, because the user dose not input too much data manually.

Besides, because the encrypted key data can be generate in random by the remote trading server, the encrypted trade data can be decrypted by only one remote trading server. Therefore, the security of the transaction can be raised.

Undoubtedly, the objective of the present invention will become obvious to those of ordinary skill in the art after reading the following detailed description of the preferred embodiment, which is illustrated in the various figures and drawings.

### BRIEF DESCRIPTION OF THE DRAWINGS

The present invention can be fully understood from the following detailed description and preferred embodiment with reference to the accompanying drawings, in which:

FIG. 1 is a function block diagram of the first embodiment of the mobile transaction system and shop client of the present invention;

FIG. 2 is a function block diagram of the first embodiment of mobile barcode trading device, data transmission server, remote trading server and shop client of the mobile barcode trading device;

FIG. 3 is illustrating the detailed trade data;

FIG. 4 is illustrating the trade data stored in the trade database; and

FIG. 5 and FIG. 5A are the flow chart of the mobile transaction method of the present invention.

### DETAILED DESCRIPTION OF THE PREFERRED EMBODIMENTS

The mobile transaction system and method as provided in accordance with the present invention can be widely applied to many kinds of transaction method of physical or internet shop, and the combined applications of the present invention are too numerous to be enumerated and described, so that only one preferred embodiment is disclosed as follows for representation.

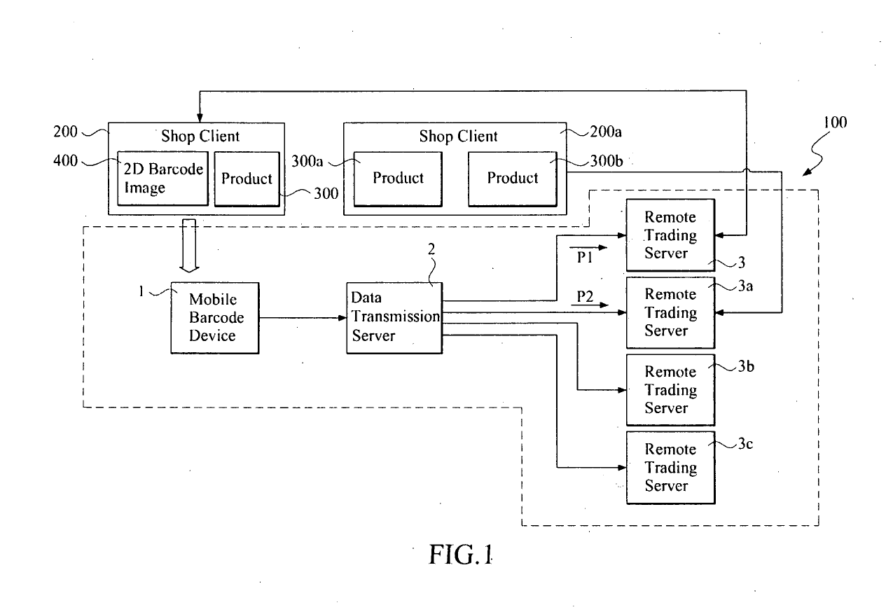

Please refer to FIG. 1, which is a function block diagram of the first embodiment of the present invention. A mobile transaction system includes a mobile barcode trading device 1, a data transmission server 2 and four remote trading servers 3, 3a, 3b and 3c. The mobile barcode trading device 1 is electrically coupled to four remote trading servers 3, 3a, 3b and 3c via the data transmission server 2. The remote trading servers 3, 3a, 3b and 3c can be disposed in four differences financial institutions or in one financial institution.

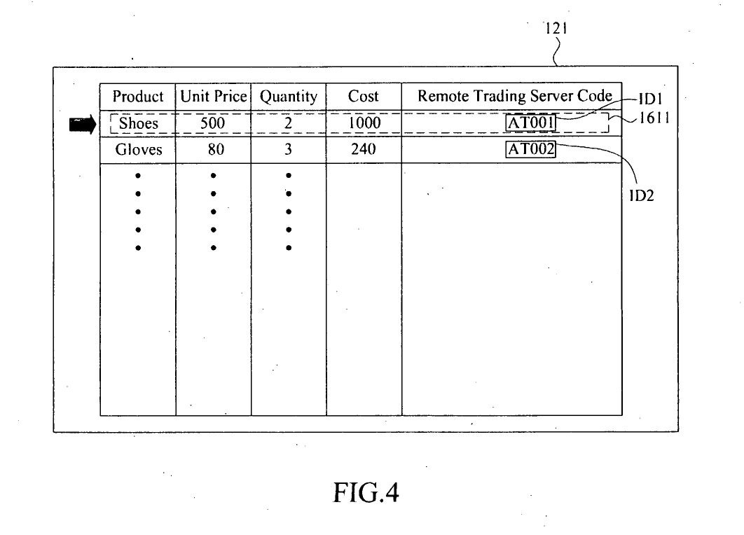

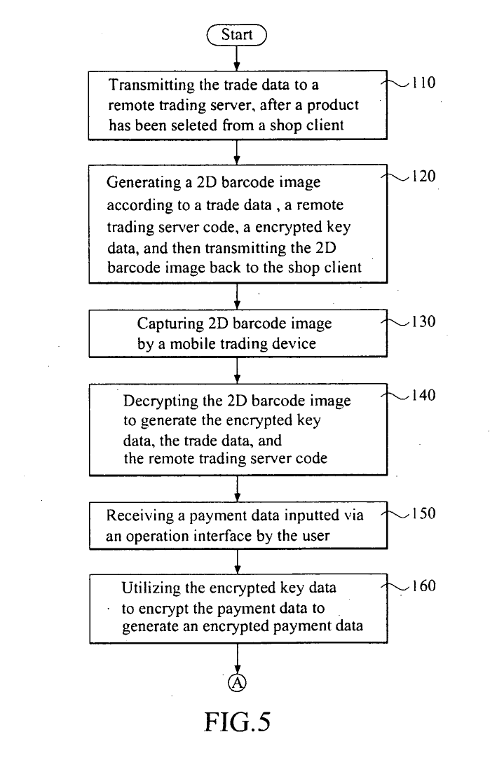

Two shop clients 200 and 200a are electrically coupled to remote trading servers 3 and 3a respectively. The remote trading server 3 has the remote trading server code ID1 (as shown in FIG. 4), the remote trading server 3a has a remote trading server code ID2 (as shown in FIG. 4). In this embodiment, the remote trading server code ID1 is AT001 (as shown in FIG. 4), the remote trading server code ID2 is AT002 (as shown in FIG. 4). Moreover, each of the remote trading servers, such as 3b and 3c, has a corresponding remote trading server code.

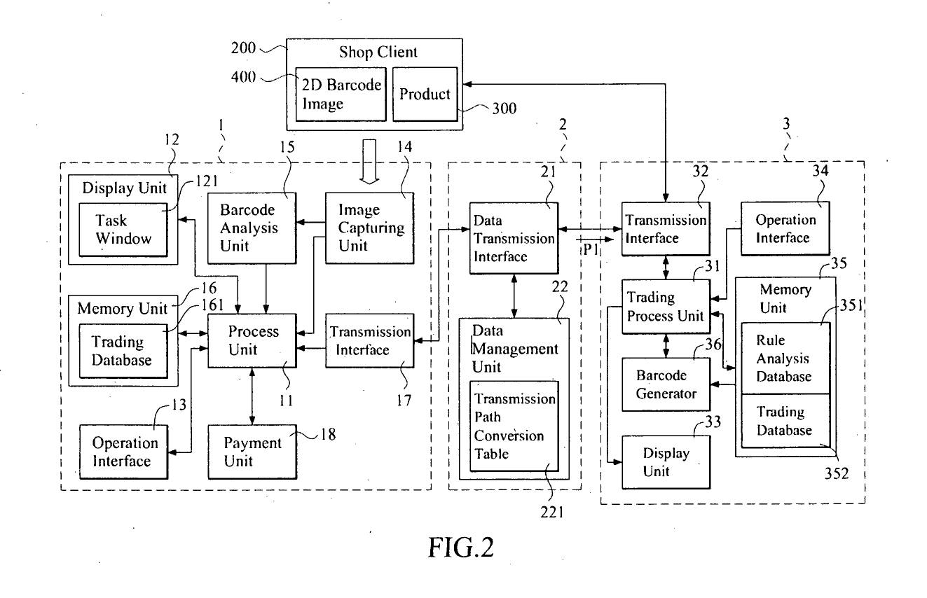

Please refer to FIG. 2, which is a function block diagram of the first embodiment of the mobile barcode trading device, the data transmission server, the remote trading server and the shop client of the present invention. As shown in FIG. 2, the mobile barcode trading device 1 includes a process unit 11, a display unit 12, an operation interface 13, an image capturing unit 14, a barcode analysis unit 15, a Memory unit 16, a transmission interface 17 and a payment unit 18.

The display unit 12, The operation interface 13, The image capturing unit 14, The barcode analysis unit 15, The memory unit 16, the transmission interface 17 and the payment unit 18 are electrically coupled to the process unit 11 respectively. The display unit 12 can display a task window 121. The user can input an operating signal according to the display of the task window 121 to the operation interface 13 to control the mobile barcode trading device 1. The Memory unit 16 includes a trade database 161. The data transmission server 2 includes a data transmission interface 21 and a data management unit 22. The data transmission interface 21 is electrically coupled to the mobile barcode trading device 1 and the remote trading server 3. The data management unit 22 is electrically coupled to the data transmission interface 21, and includes a transmission path conversion table 221.

The remote trading server 3 includes a remote trading process unit 31, a remote transmission interface 32, a remote display unit 33, a remote operation interface 34, a remote Memory unit 35 and a barcode generator 36. The remote transmission interface 32, the remote display unit 33, the remote operation interface 34, the remote memory unit 35 and the barcode generator 36 are electrically coupled to the remote trading process unit 31. The remote memory unit 35 includes a rule analysis database 351 and a remote trade database 352. At least one analysis rule is stored in the rule analysis database 351.

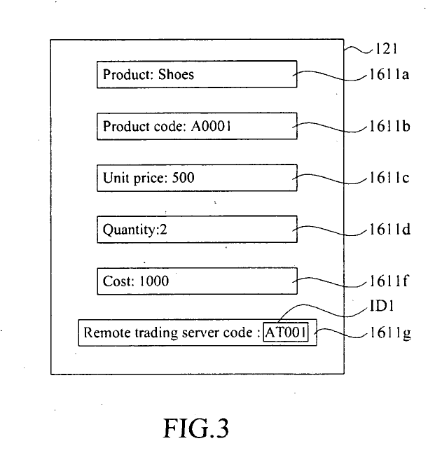

Please refer to FIG. 2, and further refer to FIG. 1, FIG. 3 and FIG. 4 as the reference. FIG. 3 is illustrating the detailed trade data; FIG. 4 is illustrating the trade data stored in the trade database. The shop client 200 generates a trade data, after a user selects a product 300 from the shop client 200. The trade data will transmit from the shop client 200 to the remote trading process unit 31 of the remote trading server 3 via the remote transmission interface 32 of the remote trading server 3. Next, the remote trading process unit 31 transmits the trade data to the barcode generator 36.

In this time, the remote trading server 3 can generate an encrypted key data by random. The barcode generator 36 can encrypt the key data and the trade data to generate a two-dimensional (2D) barcode image 400, and transmit the two-dimensional barcode image 400 to the shop client 200. Preferably, the barcode generator 36 can encrypt the key data, the trade data, and the remote trading server code ID1 to generate a two-dimensional (2D) barcode image 400.

Next, the user can use the image capturing unit 14 of the mobile barcode trading device 1 to capture the 2D barcode image 400. The image capturing unit 14 transmits the 2D barcode image 400 to the barcode analysis unit 15. The barcode analysis unit 15 can decrypt the 2D barcode image 400 to obtain the encrypted key data, the remote trading server code, and the trade data, and then the barcode analysis unit 15 can transmit the encrypted key data, the remote trading server code, and the trade data to the process unit 11.

In a preferred embodiment of the present invention, reading the trade data before paying the payment of the product 300 for protecting the benefit of consumer. Moreover, the trade data 1611 can be displayed in the task window 121 after the encrypted key data, the remote trading server code and the trade data 1611 are decrypted by the barcode analysis unit 15.

As shown in FIG. 3 the trade data 1611 shown in the task window 121 includes a product name, an unit price, a quantity, a cost and the remote trading server code (such as financial institution code) shown in the task window 121 of the display unit 12. The task window 121 can be defined a product name display area 1611a, a product code display area 1611b, a product price display area 1611c, a quantity display area 1611d, a cost display area 1611f, and a server code display area 1611g. The product name display area 1611a, the product code display area 1611b, the product price display area 1611c, the quantity display area 1611d, the cost display area 1611f, and the server code display area 1611g are for displaying the product name, the product code, the product unit price, product quantity, trading cost, and the remote trading server code ID1 of the trade data 1611 respectively.

When the user goes to pay the payment of the product 300, the user can input a payment data via the operation interface 13, and the payment unit 18 generates an encrypted payment data by an encrypted key data for the purpose of paying the payment of the product 300. Practically, the payment unit 18 can be an electronic wallet manager, a credit card data process unit, a chip reader, or a chip sensor.

When the payment unit 18 includes the electronic wallet manager, the user can pay the payment no matter the user carries a credit card or not. The user can input a payment data via operation interface 13 and chose an electronic wallet, and then the payment unit encrypts the electronic wallet data of the electronic wallet via the encrypted key data to generate the encrypted payment data. In this time, the payment data can be an electronic wallet code and/or a payment code.

When the payment unit 18 includes the credit card data process unit, the user can pay the payment no matter the user carries a credit card or not. The user can input a payment data via the operation interface 13, and then the payment unit encrypts the payment data to generate the encrypted payment data. In this time, the payment data can include a credit card data and a credit card authentication code.

When the payment unit 18 includes a chip reader, or a chip sensor, the payment unit 18 can read or sense a financial chip directly. In the other way, the user can input a payment data via the operation interface 13, and then the payment unit 18 encrypts the payment data to generate the encrypted payment data. In this time, the payment data can include a payment code of the financial chip.

The payment unit 18 including the electronic wallet manager and/or the credit card data process unit is a preferably embodiment of the above four case, because the user can pay the payment no matter the user carries a credit card or not.

After generating the above encrypted payment data, the process unit 11 can generate an encrypted trade data including the encrypted payment data, the remote trading server code ID1, and the trade data. About the first encrypted trade data, the encrypted payment data is encrypted according to the encrypted key data. Therefore, the encrypted payment data can only decrypted and read by the remote trading server 3. The remote trading server code ID1 and the trade data can be read by the mobile barcode trading device 1, the data transmission server 2 and the remote trading server 3, because them are not encrypted.

Next, the first encrypted trade data can be transmitted to the data transmission interface 21 of the data transmission server 2. In this time, data management unit 22 will analyze the remote trading server code ID1 of the encrypted trade data, and determine the corresponding transmission path of the remote trading server code ID1 via comparing the transmission path conversion table 221. Because the remote trading server code ID1 is corresponding to the remote trading server 3, the data transmission server 2 will transmit the first encrypted trade data to the remote trading server 3 via a transmission path P1. Moreover, for raising the security of transmitting the encrypted trade data, the encrypted trade data can be transmitted securely via a Secure Socket Layer (SSL).

Moreover, the first encrypted trade data can be stored in the trade data 161 of the mobile barcode trading device 1. As shown in FIG. 4, two encrypted trade data are stored in the trade data 161. In the second encrypted trade data, the remote trading server code ID2 is “AT002”, that indicates the second encrypted trade data transmitting to the remote trading server 3a via the transmission path P2.

After the remote trading server 3 receives the first encrypted trade data via the remote transmission interface 32, the remote trading server 3 transmits the first encrypted trade data to the remote trading process unit 31, and decrypts encrypted the encrypted payment data of the first encrypted trade data to generate the payment data according the analysis rule stored in the rule analysis database 351 of the remote Memory unit 35. Finally, the mobile transaction of the present invention is completed once time.

After the remote trading process unit 31 decrypts the encrypted payment data of the first encrypted trade data to obtain the payment data successfully and confirms the payment data correctly, the remote trading process unit 31 transmits a success trade signal to the process unit 11 of the mobile barcode trading device 1 to inform the user the transaction is completely. In this time, the success trade signal can also be transmitted to the shop client 200 to inform the shop client 200 to sell the product 300. A remote user in the remote trading server 3 can operate the remote operation interface 34 to control the remote trading server 3 to execute the function above via viewing the remote display unit 33.

Practically, for check the bill, the remote user can control the remote operation interface 34 to store the trade data 1611 of the first encrypted trade data and payment data in the remote trade database 352 of the remote Memory unit 35. If the user needs to cheek the bill, the user can download the trade data 1611 from the remote trade database 352 directly.

People skilled in ordinary arts can easily find that the mobile barcode trading device 1 can be a mobile phone, a Personal Digital Assistant (PDA), or other mobile electronic communication devices. The shop clients 200 and 200a can be a physical shop or an internet shop. When the shop clients 200 or 200a can be a physical shop, the 2D barcode image will display on the screen of the cash register after selects the product. When the shop client 200 and 200a are an internet shop, the 2D barcode image 400 and 400a will display on a payment webpage of the website of the internet shop.

People skilled in ordinary arts can easily find that the mobile barcode trading device 1 of the mobile transaction system 100 of the present invention includes the payment unit 18. Therefore, the user can complete the mobile transaction without any credit card. In this time, the mobile barcode trading device 1 of the mobile transaction system 100 of the present invention includes the image capturing unit 14 and the barcode analysis unit 15. Therefore, the image capturing unit 15 can capture 2D barcode image, and the encrypted trade data and the trade data can be decrypted from the 2D barcode image by barcode analysis unit 15. Obviously, regarding to the mobile transaction system of the present invention, there are not too much data to be imputed by a user. Therefore, the mistake of inputting will be deceasing.

Regarding to the first encrypted trade data, the encrypted key data is randomly generated by the remote trading server 3. Only the remote trading server 3 can decrypt the encrypted trade data. Therefore, the security of transmitting transaction data can be raised.

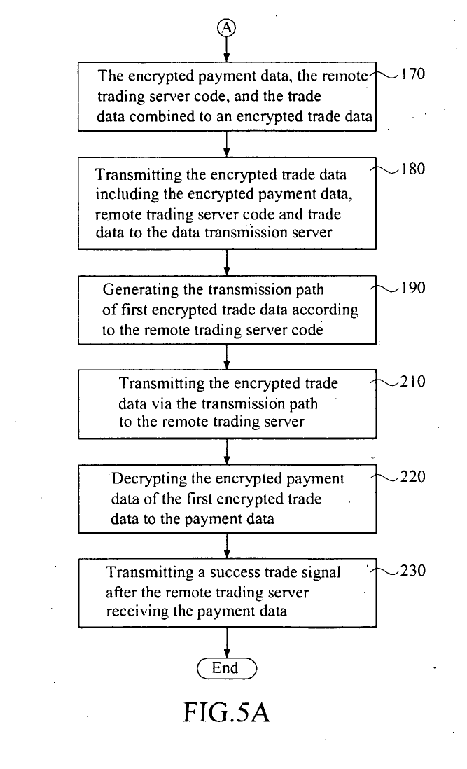

Please refer to FIG. 5 and FIG. 5A, which are the flow chart of the mobile transaction method of the present invention. Besides, please take the FIG. 1 and FIG. 2 as reference. As shown in the figures, the shop client 200 transmits the trade data to the remote trading server 3, after the user selects the product 300 from a shop client 200 (Step 110).

The remote trading server 3 generates the 2D barcode image 400 according to the trade data, an encrypted key data generated by the remote trading server, a remote trading server code ID1 corresponding to the encrypted key. Next the remote trading server 3 transmits the 2D barcode image 400 back to the shop client 200 for displaying (Step 120).

Next, the mobile trading device 1 captures 2D barcode image 400 (Step 130).

The mobile trading device 1 decrypts the 2D barcode image 400 to obtain the encrypted key data, the trade data, and the remote trading server code ID1 (Step 140).

Next, the user can input the payment data via the operation interface 13, and the mobile trading device 1 receives the payment data from the operation interface 13 (Step 150). The mobile trading device 1 encrypts the payment data to generate an encrypted payment data according to the encrypted key data (Step 160).

Preferably, the mobile trading device 1 can control the encrypted payment data, the remote trading server code, and the trade data to be added into an encrypted trade data (Step 170), and transmits the encrypted trade data, which including the encrypted payment data, the remote trading server code and trade data, to the data transmission server (Step 180), The data transmission server 2 deter mines the transmission path P1 of first encrypted trade data according to the remote trading server code ID1 (Step 190).

After the data transmission server 2 determines the transmission path P1 of the first encrypted trade data, the data transmission server 2 transmits the encrypted trade data via the transmission path P1 to the remote trading server 3 (Step 210). After the first encrypted trade data is received by the remote trading server 3, the remote trading server 3 decrypts the encrypted payment data of the first encrypted trade data to obtain a payment data (Step 220), The remote trading server 3 transmits a success trade signal, after the remote trading server 3 gets the payment data successfully (Step 230). Preferably, the success trade signal can be transmitted to the shop client 200 and the mobile trading device 1 at the same time. Therefore, the operator in the shop client 200 (such as cash register of the physical store) and the user holding the mobile trading device 1 can know the transaction have been completed.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A mobile transaction system to capture a two-dimensional barcode image for a mobile transaction, the two-dimensional barcode image can be displayed on the shop client after a user selecting at least one product, the mobile transaction system comprising:
a plurality of remote trading servers electrically coupled to the shop client, one of the remote trading servers receiving a trade data transmitted by the shop client after the user selecting the product, and generating a two-dimensional barcode image to the shop client;
a mobile barcode trading device comprising:
an image capturing unit for capturing the two-dimensional barcode image;
a barcode analysis unit electrically coupled to the image capturing unit to analyze the two-dimensional barcode image to obtain an encrypted key data and the trade data from; and
a payment unit electrically coupled to the barcode analysis unit, and generating an encrypted payment data according to the encrypted key data after the user inputting a payment data for the user paying the payment of the product;
a data transmission server electrically coupled to the remote trading server and the mobile barcode trading device;
wherein, the encrypted payment data and the trade data are to be an encrypted trade data, the encrypted trade data is transmitted to the one of the remote trading servers via the data transmission server and at least one transmission path.

2. The mobile transaction system according to claim 1, wherein the mobile barcode trading device further includes a process unit, the process unit is electrically coupled to the barcode analysis unit and the payment unit to make the encrypted payment data and the trade data to be an encrypted trade data.

3. The mobile transaction system according to claim 1, wherein the mobile barcode trading device further includes an operation interface, the operation interface is electrically coupled to the process unit for the user inputting an operating signal.

4. The mobile transaction system according to claim 2, wherein the mobile barcode trading device further includes a transmission interface, the transmission interface is electrically coupled to the process unit for transmitting the encrypted trade data to the data transmission server.

5. The mobile transaction system according to claim 4, wherein the transmission interface is an internet transmission interface, the encrypted trade data transmitted via Secure Socket Layer (SSL).

6. The mobile transaction system according to claim 2, wherein the mobile barcode trading device further includes a display unit, the display unit is electrically coupled to the process unit for a task window displaying the trade data and the payment data.

7. The mobile transaction system according to claim 2, wherein the mobile barcode trading device further includes a memory unit, the memory unit is electrically coupled to the process unit, the memory unit includes a trade database to record the encrypted key data and the trade data.

8. The mobile transaction system according to claim 1, wherein the payment unit includes an electronic wallet manager.

9. The mobile transaction system according to claim 1, wherein the payment unit includes a credit card data process unit and the payment data includes a credit card data and a credit card authentication code.

10. The mobile transaction system according to claim 1, wherein the payment unit includes a chip reader to read a financial chip.

11. The mobile transaction system according to claim 1, wherein the payment unit includes a chip sensor to sense a financial chip.

12. The mobile transaction system according to claim 1, wherein the data transmission server includes:
a data transmission interface electrically coupled to the mobile barcode trading device and the remote trading servers to receiving the encrypted trade data; and
a data management unit electrically coupled to the data transmission interface to manage the transmission path.

13. The mobile transaction system according to claim 12, wherein each of the remote trading servers having a remote trading server code respectively, the data management unit includes a transmission path conversion table, the data management unit determines the transmission path of the encrypted trade data according to the remote trading server code and the transmission path conversion table.

14. The mobile transaction system according to claim 1, wherein the remote trading server includes:
a remote transmission interface electrically coupled to the data transmission server to receive the encrypted trade data; and
a remote trading process unit electrically coupled to the remote transmission interface to decrypt the encrypted trade data to obtain the payment data, and confirms the payment data.

15. The mobile transaction system according to claim 14, wherein the remote trading process unit transmits a success trade signal to the process unit and the shop client via the remote transmission interface and the data transmission server sequentially after obtaining the payment data and confirming the payment data is correct.

16. The mobile transaction system according to claim 14, wherein the remote trading server includes a remote Memory unit, the remote memory unit is electrically coupled to the remote trading process unit, and the remote memory unit includes a rule analysis database, at least on analysis rule is stored in the rule analysis database for the remote trading process unit determining the payment data.

17. The mobile transaction system according to claim 16, wherein the remote memory unit includes a remote trade database for storing the trade data, the encrypted key data and the payment data.

18. The mobile transaction system according to claim 14, wherein each of the remote trading server has a remote trading server code, each of the remote trading server further a barcode generator, the barcode generator is electrically coupled to the remote Memory unit and the remote trading process unit, the remote trading server generates the trade data after the user selects the product from the shop client, and transmits the trade data to one of the remote trading servers, generates the two-dimensional barcode image according the encrypted key data, the trade data and the remote trading server code after the encrypted key data generated by the remote trading server, transmits the two-dimensional barcode image to the shop client to display.

19. The mobile transaction system according to claim 14, wherein the remote trading server further includes a remote operation interface, the remote operation interface is electrically coupled to the remote trading process unit for a user controlling the remote trading server.

20. The mobile transaction system according to claim 14, wherein the remote trading server includes a remote display unit, the remote display unit is electrically coupled to the remote trading process unit.

21. The mobile transaction system according to claim 1, wherein the mobile barcode trading device is a mobile phone.

22. The mobile transaction system according to claim 1, wherein the mobile barcode trading device is a Personal Digital Assistant (PDA).

23. The mobile transaction system according to claim 1, wherein the shop client is an internet shop.

24. The mobile transaction system according to claim 1, wherein the shop client is a physical shop.

25. A mobile transaction method comprising the following step:
(a) displaying a two-dimensional barcode image in a shop client after a user selecting at least one product;
(b) capturing the two-dimensional barcode image via a mobile barcode trading device;
(c) decrypting the two-dimensional barcode image to obtain an encrypted key data and a trade data via the mobile barcode trading device;
(d) receiving a payment data from the user via the mobile barcode trading device;
(e) utilizing the encrypted key data to encrypt the payment data to generate an encrypted payment data; and
(f) transmitting the encrypted payment data, the remote trading server code, and the trade data to one of the remote trading server via a data transmission server and at least one transmission path.

26. The mobile transaction method according to claim 25, wherein in the step (a), the shop client transmits a trade data to one of the remote trading servers after the user selecting the product from the shop client, the one of the remote trading servers generates the two-dimensional barcode image according to the trade data and the encrypted key data, and transmits the two-dimensional barcode image to the shop client to display.

27. The mobile transaction method according to claim 25, wherein each of the remote trading servers has a remote trading server code, in the step (c), the remote trading server code is decrypted from the two-dimensional barcode image.

28. The mobile transaction method according to claim 27, wherein in the step (f), the data transmission server determines the transmission path according to the remote trading server code.

29. The mobile transaction method according to claim 25, wherein the step (e) further includes a step (e1):
generating an encrypted trade data including the encrypted payment data and the trade data, wherein the encrypted trade data can be read by one of the remote trading servers only.

30. The mobile transaction method according to claim 25, wherein further includes a step (g) after the step (f):
decrypting the encrypted payment data to obtain the payment data by one of the remote trading servers.

31. The mobile transaction method according to claim 30, wherein further includes a step (h) after the step (g):
transmitting a success trade signal after one of the remote trading servers generating the payment data successfully.

32. The mobile transaction method according to claim 25, wherein the mobile barcode trading device is a mobile phone.

33. The mobile transaction method according to claim 25, wherein the mobile barcode trading device is a Personal Digital Assistant (PDA).

34. The mobile transaction method according to claim 25, wherein the shop client is an internet shop.

35. The mobile transaction method according to claim 25, wherein the shop client is a physical shop.
